(19) United States
(12) Patent Application Publication
(10) Pub. No.: US 2022/0185354 A1
(43) Pub. Date: Jun. 16, 2022

(54) Detachable Tongue Apparatus and Method for Converting a Two-Wheeled Wheelbarrow into a Towable Cart

(71) Applicant: Kenneth A. LaPlante, Kansasville, WI (US)

(72) Inventor: Kenneth A. LaPlante, Kansasville, WI (US)

(21) Appl. No.: 17/643,951

(22) Filed: Dec. 13, 2021

Related U.S. Application Data
(60) Provisional application No. 63/126,211, filed on Dec. 16, 2020.

(51) Int. Cl. B62B 5/00; B62B 1/20; B62B 1/24

(52) U.S. Cl. CPC B62B 5/0079; B62B 1/24; B62B 1/20

(57) ABSTRACT

An apparatus and method for converting a two-wheeled wheelbarrow into a towable cart utilize a detachable towing tongue having a first end adapted for pivotable attachment to an axle of the wheelbarrow between the two wheels, a second end adapted for attachment to a towing vehicle, and a tongue body extending between the first and second ends. The tongue body defines an upper surface that includes a wheelbarrow intermediate support surface configured for engaging a lower surface of the wheelbarrow. In some forms, without detaching the hitch end of the tongue from the towing vehicle, the wheelbarrow may be selectively pivoted between a transport position of the wheelbarrow in which the lower surface of the wheelbarrow is supported by the intermediate support surface of the tongue, and a dump position whereat the lower surface of the wheelbarrow is pivoted away from the intermediate support surface of the tongue.

### CROSS-REFERENCE TO RELATED PATENT APPLICATIONS

This patent application claims the benefit of U.S. Provisional Patent Application No. 63/126,211, filed Dec. 16, 2020, the entire teachings and disclosure of which are incorporated herein by reference thereto.

### FIELD OF THE INVENTION

This invention generally relates to towing hitches and methods, and more particularly to towing hitches and methods for adapting a conventional two-wheeled wheelbarrow into a towable cart for use with a variety of motorized tow vehicles, such as riding lawn mowers, ATVs, etc.

### BACKGROUND OF THE INVENTION

It has long been recognized that it would be advantageous to have the option of conveniently converting a common wheelbarrow into a truly serviceable cart that could be towed behind a motorized vehicle in situations that commonly confront those needing to move various types of materials or payloads in home, recreation, or construction environments. While some loads can conveniently and safely be moved in an unpowered wheelbarrow, moving heavy loads, moving loads over longer distances, or moving loads over challenging terrain can be greatly facilitated by using a towable trailer. In many cases such activities could be particularly facilitated by using a towable dump trailer.

Although there have been attempts in the past to provide wheelbarrows that could be converted into towable carts or dump carts, or conversely to provide small carts that could be converted into wheelbarrows, those previous approaches have generally been less than satisfactory, typically leading to the necessity for purchasing, storing and maintaining a separate wheelbarrow and towable cart or dump cart in order to have fully capable utility under both manual and towed operating conditions. Having to purchase, maintain, and provide storage and transportation to a worksite for both a wheelbarrow and a towable cart result in undesirable cost, complexity and waste of storage and transportation resources.

Previous approaches to actually providing wheelbarrows that could be converted into towable carts, or vice-versa, have generally resulted in compromised performance in one or both of manual and towed operating modes. Previous approaches have also required undesirable complexity and higher cost than is reasonable, making such approaches unattractive compared to simply buying, maintaining and storing a separate wheelbarrow and towable cart. Further improvement is highly desirable. For example, it is desirable to have an improved approach wherein a convertible wheelbarrow/cart would work just as well as two stand-alone devices in either a manual or towed mode of operation. It is desirable to have an improved towable dump cart embodiment that can be dumped without having to be detached from the towing vehicle. And it is desirable to have an approach that can be converted for use alternatively as a manual wheelbarrow or a towable cart quickly, and without the use of tools. It is yet further desirable to have an arrangement in which the ground clearance available under a wheelbarrow used as a towable cart can be conveniently adjusted to a desired minimum distance to accommodate the hitch height of a towing vehicle and the configurations of various models of wheelbarrows that might be utilized in practicing the invention.

### BRIEF SUMMARY OF THE INVENTION

The present invention provides an apparatus and method for converting a two-wheeled wheelbarrow into a towable cart by utilizing a detachable towing tongue having a first end adapted for attachment to an axle of the wheelbarrow between the two wheels, a second, hitch end adapted for attachment to a towing vehicle, and a tongue body extending between the first and second ends. The tongue body defines an upper surface that includes a wheelbarrow intermediate support surface configured for engaging a contact point defined by a lower surface of the wheelbarrow or an extension of the lower surface of the wheelbarrow provided by a spacer element. In various forms, the invention provides improved utility and convenience and greater strength when compared to prior approaches to providing convertible wheelbarrows or towable carts.

In some forms of the invention, a conventional two-wheeled wheelbarrow is conveniently and quickly converted into a towable dump cart, configured such that, without detaching the hitch end of the tongue from the towing vehicle, the wheelbarrow may be selectively pivoted between a transport position of the wheelbarrow in which the lower surface of the wheelbarrow is supported by the intermediate support surface of the tongue, and a dump position where the lower surface of the wheelbarrow is pivoted away from the intermediate support surface of the tongue.

In one form of the invention, an apparatus is provided for converting a two-wheeled wheelbarrow into a towable cart for transport across a ground surface by a towing vehicle having a hitch defining a hitch height.

The wheelbarrow defines a longitudinal axis, front and rear ends, and a lower surface of the wheelbarrow, and includes a pair of wheels for supporting and transporting the wheelbarrow across the ground surface. The wheels are rotatably affixed adjacent the forward end of the wheelbarrow to an axle in a spaced-apart relationship along a common axis of rotation of the wheels defined by the axle. The axle is attached to the lower surface of the wheelbarrow and extends generally transverse to the longitudinal axis of the wheelbarrow. The lower surface of the wheelbarrow further defines at least one rear end support for supporting the rear end of the wheelbarrow in a resting position on the ground surface when the wheelbarrow is used in a typical, manual mode of operation.

The towing tongue has a first end adapted for pivotable attachment to the axle between the two wheels, a second, hitch end adapted for attachment to a hitch of the towing vehicle, and a tongue body extending between the first and second ends. The tongue body defines an upper surface of the tongue, and further defines a wheelbarrow intermediate support surface on the upper surface of the tongue which is configured and disposed for engaging the lower surface of the wheelbarrow at a contact point located on and defined by the lower surface, or an extension of the lower surface of the wheelbarrow. The contact point is located to the rear of the wheels when the wheelbarrow is towed backwards/opposite from its normal direction of travel in the manual mode of operation by the tongue while the wheelbarrow is being used as a towable cart. The tongue is yet further configured to allow for pivoting the wheelbarrow about the axis of rotation of the wheels to raise the rear end support of the wheelbarrow free of the ground surface when the first end of the towing tongue is pivotably attached to the axle and the second end of the towing tongue is raised to a tongue contact height of less than the hitch height from the ground surface, and further configured to continue lifting the rear end support of the wheelbarrow to a predetermined desired clearance distance above the ground surface as the hitch end of the tongue is lifted to the hitch height. Some forms of the invention include a spacer element for adjusting the clearance distance above the ground surface to a desired height.

In some forms of the invention, a towable dump cart arrangement is provided by rotatably attaching the front end of the towing tongue to the axle in such a manner that, without detaching the hitch end of the towing tongue from the towing vehicle, the wheelbarrow may be selectively pivoted about the axis of rotation of the wheels between a transport position of the wheelbarrow in which the lower surface of the wheelbarrow is supported by the intermediate support surface of the tongue, to a dump position of the wheelbarrow where the lower surface of the wheelbarrow is pivoted away from the intermediate support surface of the tongue.

In an apparatus or method, according to the invention, the towing tongue may be configured in such a manner that it may be removably attachable and detachable to the wheelbarrow without the use of tools.

Some forms of the invention may further include a latching arrangement for securing the body of the towing tongue to the wheelbarrow at a point aft of the wheels, to thus secure the wheelbarrow to the towing tongue when the lower surface of wheelbarrow is resting on the intermediate support surface of the towing tongue. In some forms of the invention, the latching arrangement may include an elastomeric latch or hold-down element. In other forms of the invention, the latching arrangement may utilize a removable locking pin. In some forms of the invention having a spacer element, the latching arrangement may incorporate the spacer element. A latching arrangement, according to the invention, may be configured for latching and unlatching the wheelbarrow from the tongue without the use of tools. In some embodiments the wheel barrow may be unlatched from the tongue while the wheelbarrow remains hitched to the tow vehicle.

Where the wheelbarrow includes one or more handles extending from the rear of the wheelbarrow for utilizing the wheelbarrow in a manual mode of operation, the towing tongue may be configured such that the wheelbarrow may be towed by the towing vehicle while the one or more handles remain in their normal position extending from the rear of the wheelbarrow. The towing tongue in some forms of the invention may be configured such that the one or more handles extending from the rear of the wheelbarrow may be used to facilitate pivoting the wheelbarrow between the transport and dump positions of the wheelbarrow while the towing tongue is hitched to the towing vehicle.

In some embodiments of the invention, the towing tongue may be configured in such a manner that it is attachable to a standard two-wheeled wheelbarrow without modifying the wheelbarrow, or with only minimal modifications to the wheelbarrow.

The invention may be practiced as a method for converting a two-wheeled wheelbarrow into a towable cart for transport across a ground surface by a towing vehicle having a hitch defining a hitch height, utilizing a two-wheeled wheelbarrow and detachable towing tongue in accordance the invention. In some forms of a method, according to the invention, a two-wheeled wheelbarrow is converted into a towable dump cart for transport across a ground surface by a towing vehicle having a hitch defining a hitch height, utilizing a two-wheeled wheelbarrow and detachable towing tongue in accordance the invention.

A method for converting a two-wheeled wheelbarrow into a towable cart for transport across a ground surface by a towing vehicle having a hitch defining a hitch height, may include the steps of: (a) providing a wheelbarrow defining a longitudinal axis thereof, front and rear ends thereof and a lower surface thereof and including a pair of wheels for supporting and transporting the wheelbarrow across the ground surface, the wheels being rotatably affixed adjacent the forward end of the wheelbarrow to an axle in a spaced-apart relationship along a common axis of rotation of the wheels defined by the axle, the axle being attached to the lower surface of the wheelbarrow and extending generally transverse to the longitudinal axis of the wheelbarrow, the lower surface of the wheelbarrow further defining a rear end support for supporting the rear end of the wheelbarrow in a resting position; (b) providing a towing tongue apparatus including a towing tongue having a first end adapted for pivotable attachment to the axle between the two wheels, a second end adapted for attachment to the towing vehicle, and a tongue body extending between the first and second ends, where the tongue body defines an upper surface thereof and further defines a wheelbarrow intermediate support surface configured and disposed for contacting the lower surface of the wheelbarrow at a point on the lower surface of the wheelbarrow located to the rear of the wheels along the longitudinal axis and pivoting the wheelbarrow about the axis of rotation of the wheels to raise the rear end support of the wheelbarrow free of the ground surface when the first end of the towing tongue is pivotably attached to the axle of the wheelbarrow and the second end of the towing tongue is raised to a tongue contact distance of less than the hitch height from the ground surface, and further configured to lift the rear end support of the wheelbarrow to a predetermined desired clearance distance above the ground surface when the hitch end of the tongue is lifted to the hitch height; and (c) operatively attaching the first end of the towing tongue to the axle of the wheelbarrow between the wheels, with the body of the tongue extending beneath the wheelbarrow along the longitudinal axis of the wheelbarrow, the upper surface of the tongue facing the lower surface of the wheelbarrow, and the second end of the tongue extending from the rear end of the wheelbarrow.

Where a towing tongue apparatus further includes a latching arrangement for securing the wheelbarrow to the tongue, a method according to the invention may further include securing the wheelbarrow to the tongue with the latching arrangement.

Where the towing tongue apparatus includes a spacer element operatively disposed between the wheelbarrow and the towing tongue, with the spacer element having a spacer element body configured to raise the rear end support of the wheelbarrow free of the ground surface when the second end of the towing tongue is raised to a tongue contact distance of less than the hitch height from the ground surface and further configured to lift the rear end support of the wheelbarrow to a predetermined desired clearance distance above the ground surface when the hitch end of the tongue is lifted to the hitch height, a method according to the invention may further include utilizing the spacer element to adjust the predetermined desired clearance distance to a desired height.

In some forms of the invention, to facilitate shipping and storage of the towing tongue apparatus, the towing tongue may be configured to include a first and a second section thereof extending along a common longitudinal axis of the tongue and fixedly joinable to one another at respective proximal ends thereof by a coupler, with the distal end of the first section of the tongue comprising the first end of the tongue, and the distal end of the second section of the tongue comprising the second, hitch end of the tongue.

A method, according to the invention, may also include one or more of the following additional steps: (a) configuring the first end of the towing tongue to be attachable to and detachable from the wheelbarrow without the use of tools; (b) pivotably attaching the first end of the towing tongue to the axle in such a manner that, without detaching the hitch end of the towing tongue from the towing vehicle, the wheelbarrow may be selectively pivoted about the axis of rotation of the wheels between a transport position of the wheelbarrow in which the lower surface of the wheelbarrow is supported by the intermediate contact surface of the tongue, to a dump position of the wheelbarrow whereat the lower surface of the wheelbarrow is pivoted away from the intermediate support surface of the tongue; (c) where the wheelbarrow includes one or more handles extending from the rear of the wheelbarrow for utilizing the wheelbarrow in a manual mode of operation, configuring the towing tongue such that the wheelbarrow may be towed by the towing vehicle while the one or more handles are extending in their normal position from the rear of the wheelbarrow; (d) utilizing the one or more handles extending from the rear of the wheelbarrow to facilitate moving the wheelbarrow between the transport and dump positions of the wheelbarrow while the towing tongue is hitched to the towing vehicle; and (e) where the tongue comprises a first and a second section thereof extending along a common longitudinal axis of the tongue and fixedly joinable to one another at respective proximal ends thereof by a coupler, the distal end of the first section of the tongue comprising the first end of the tongue, and the distal end of the second section of the tongue comprising the second end of the tongue, utilizing the coupler to place the tongue in a desired joined or un-joined configuration.

The invention may take the form of a convertible two-wheeled wheelbarrow and/or towable cart and/or dump cart arrangement for transporting loads across a ground surface manually or by a towing vehicle.

Other aspects, objects and advantages of the invention will be apparent from the following detailed description taken in conjunction with the accompanying drawings and illustrations.

### BRIEF DESCRIPTION OF THE DRAWINGS

The accompanying drawings and illustrations incorporated into and forming part of the specification illustrate several aspects of the present invention and, together with the description, serve to explain the invention. In the drawings:

FIG. 1 is an isometric view of a first exemplary embodiment of a towing tongue arrangement, according to the invention;

FIGS. 2 and 3 are side elevation views showing the towing tongue of FIG. 1 being used to convert a standard two-wheeled wheelbarrow into a dump cart connected to a towing vehicle, with FIG. 2 showing the wheelbarrow in a transport position of the dump cart, and with FIG. 3 showing the wheelbarrow in a dump position of the dump cart;

FIG. 4 is a bottom view of the wheelbarrow of FIGS. 2 and 3 illustrating salient features of the wheelbarrow;

FIGS. 5-8 are perspective views, from various viewpoints, with the wheelbarrow in an inverted position for clarity of illustration, illustrating the manner in which a first end of the towing tongue of the first exemplary embodiment is configured and attached to the axle of the two-wheeled wheelbarrow, between the two wheels;

FIGS. 9-11 are perspective views illustrating the components and operation of a latching arrangement of the exemplary embodiment of the first exemplary embodiment of a towing tongue arrangement according to the invention, which is provided to selectively latch the rear end of the wheelbarrow to an intermediate support surface of the towing tongue;

FIGS. 12-14 are perspective views showing operation of the latching arrangement of the first exemplary embodiment of the invention in various operating modes, with FIG. 12 showing the latching arrangement engaged while the towing tongue is connecting the wheelbarrow to a towing vehicle and the wheelbarrow in the transport position, FIG. 13 showing the latching arrangement engaged with the towing tongue disconnected from the towing vehicle and the wheelbarrow in the transport position, and FIG. 14 showing the latching arrangement dis-engaged with the towing tongue connecting the wheelbarrow to the towing vehicle and the wheelbarrow in the dump position;

FIG. 15 is a perspective close-up view of the first end of the first exemplary embodiment of the towing tongue with the wheelbarrow in the dump position while connected to the towing vehicle by the towing tongue, in the manner shown in FIG. 14, illustrating the manner in which the towing tongue is configured to facilitate full normal dumping operation of the wheelbarrow while it remains connected by the towing tongue to the towing vehicle;

FIG. 16 is an isometric view of a second exemplary embodiment of a towing tongue arrangement, according to the invention;

FIG. 17 is an exploded isometric view of the second exemplary embodiment of the towing tongue arrangement shown in FIG. 16, to better illustrate some of the details and interconnections of the component parts of the second exemplary embodiment of a towing tongue arrangement according to the invention;

FIG. 18 is an isometric view of a portion of a first end of a towing tongue of the second towing tongue arrangement of FIG. 1;

FIG. 19 is an isometric view of a spacer element of the second towing tongue arrangement of FIG. 1;

FIGS. 20 and 21 are partial orthographic rear and left side views of the spacer element of FIG. 19 installed in a first position on a wheelbarrow to establish a first ground clearance distance beneath the wheelbarrow when configured in a towable mode according to the invention; and

FIGS. 22 and 23 are partial orthographic rear and left side views of the spacer element of FIG. 19 installed in a second position on a wheelbarrow to establish a second ground clearance distance beneath the wheelbarrow, greater than the ground clearance distance provided by the positioning shown in FIGS. 20-21, when configured in a towable mode according to the invention; and

While the invention is described herein with reference to certain exemplary embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

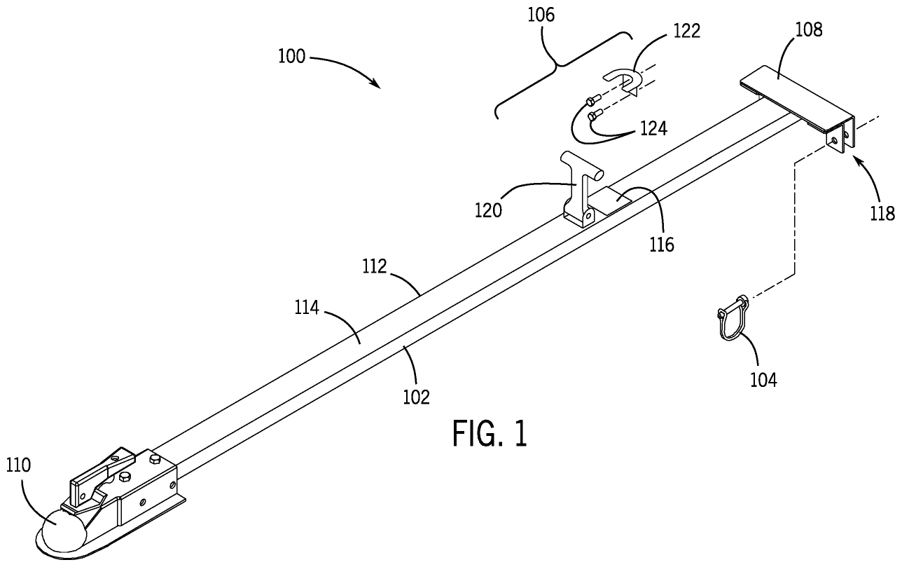

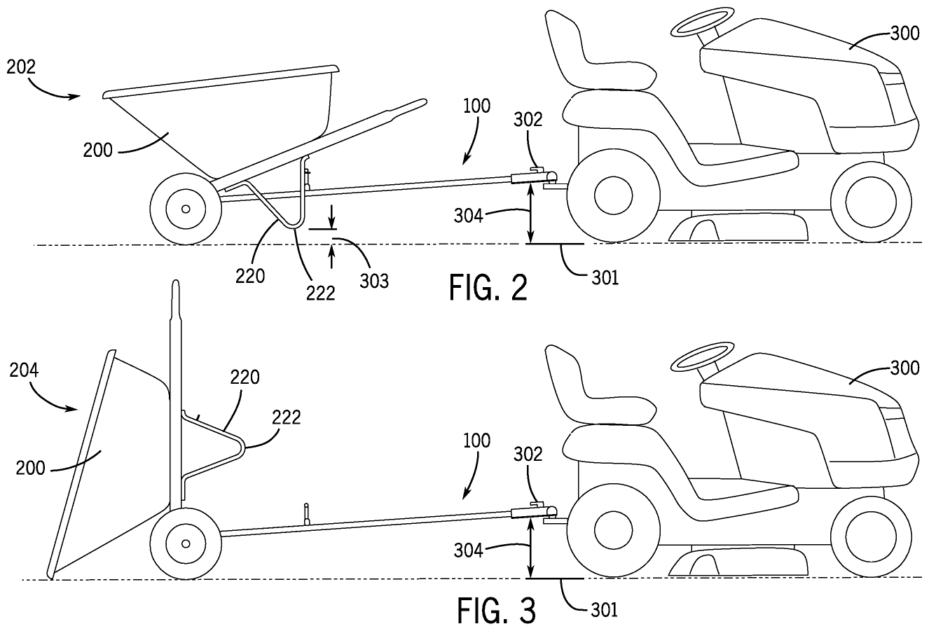

Referring to FIGS. 1-3, FIG. 1 shows a first exemplary embodiment of the invention in the form of a towing tongue apparatus or arrangement 100 for converting a two-wheeled wheelbarrow 200 into a towable dump cart that is operable in either a transport position 202 or a dump position 204 when hitched to a towing vehicle 300 in the manner illustrated respectively in FIGS. 2 and 3.

In FIGS. 2 and 3 the towing vehicle is a lawn tractor 300, but it will be understood that the invention is not limited to use with lawn tractors or to any particular style of wheelbarrow and may be practiced with efficacy with a wide variety of towing vehicles including cars, trucks, tractors, ATVS, golf carts, gators, etc. The invention allows the towing vehicle 300 to transport the converted wheelbarrow 200 across a surface, as represented by the ground surface 301 under the lawn tractor 300 and wheelbarrow 200 in FIGS. 2 and 3, when the towing tongue apparatus 100 is operatively connected between the wheelbarrow 200 and a hitch 302 of the towing vehicle 300. The hitch 302 defines a hitch height 304 above the ground surface 301. As used herein, it will be understood by those having skill in the art that the terms “surface” or “ground surface” are not intended to limit the scope of the invention to use on turf or other natural surfaces of the earth, but are rather intended to be construed broadly to include any natural or manmade surface over which a towing vehicle 300 might conceivably tow a wheelbarrow 200 when practicing the invention.

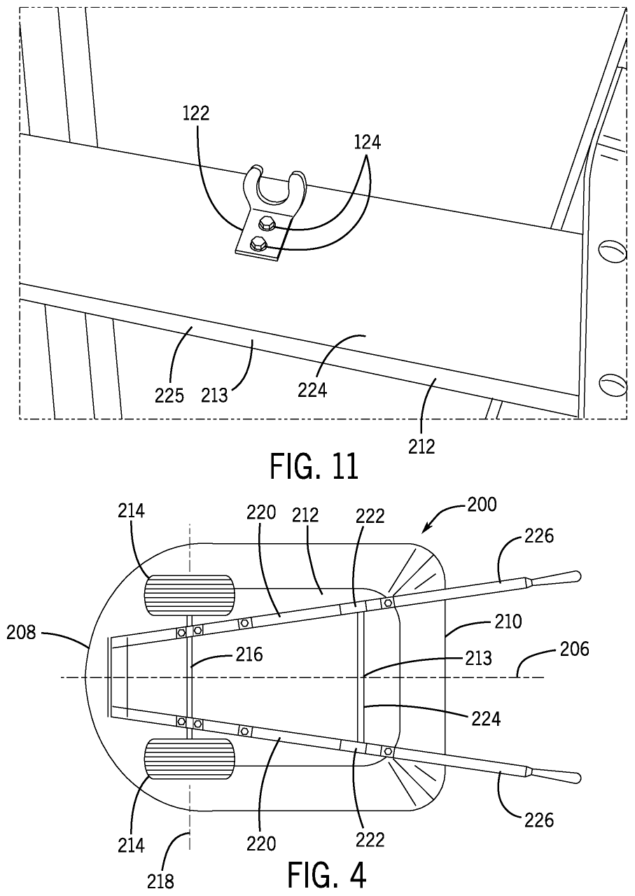

As shown in FIG. 4, the wheelbarrow 200 defines a longitudinal axis 206 thereof, front and rear ends 208,210 thereof, a lower surface 212 thereof, and includes a pair of wheels 214,214 for supporting and transporting the wheelbarrow 200 across the ground surface 301. With regard to the wheelbarrow 200, naming conventions for the front and rear ends 208,210 are with reference to the direction of travel when the wheelbarrow is operated in its normal, manual mode of operation, pushed by a person lifting a pair of handles 226 extending from the rear of the wheelbarrow 200. The wheels 214,214 are rotatably affixed adjacent the front or forward end 208 of the wheelbarrow 200 to an axle 216 in a spaced-apart relationship along a common axis of rotation 218 of the wheels 214,214 defined by the axle 216.

As used herein, the term “lower surface 212” of the wheelbarrow 300 includes any portion of the wheelbarrow 200, other than the wheels 214,214 or axle 218, that faces the ground surface 301. In the particular wheelbarrows 200 shown in the attached drawings, a material carrying pan or tub is generally attached to a support frame or structure that includes various attachment brackets for the axle 216 and left and right rear legs 220,220 joined together by a rear frame crossmember 224 for supporting the rear 210 of the wheelbarrow 200 when it is being used in a typical manual mode, or not attached to a towing vehicle 300. The ground-facing surfaces of all of these structures are considered to be part of the “lower surface 212” of the wheelbarrow 300, as that term is used in describing the invention. This is considered appropriate given the nature of the invention and the wide scope of potential wheelbarrow constructions, including some having molded or formed bodies including fewer parts than the wheelbarrows shown in the exemplary embodiments described herein. In some of these alternate constructions, features equivalent to the rear legs 220,220 and rear frame crossmember 224 might be integrally molded or formed with the pan, for example. It is contemplated that the invention could be practiced with efficacy with such alternate forms of wheelbarrows within the scope of the invention as properly construed.

As further illustrated in FIG. 4, the axle 218 is attached by brackets to a frame forming part of the lower surface 212 of the wheelbarrow 200 and extends generally transverse to the longitudinal axis 206 of the wheelbarrow 200.

As discussed above, and illustrated in FIGS. 2-4, the lower surface 212 of each of the exemplary embodiments of the wheelbarrows 200 shown in the attached illustrations also further includes a pair of rear legs 220,220 which each define a respective rear end support 222,222 for supporting the rear end 210 of the wheelbarrow 200 in a resting position on the ground surface 301 when the wheelbarrow 200 is used in a normal manual mode of operation.

Returning to FIG. 1, the first exemplary embodiment of the towing tongue arrangement 100 includes a towing tongue 102, a pair of retainer pins 104,104 (only one of which is shown in FIG. 1) for securing the towing tongue 102 to the axle 216 of the two-wheeled wheelbarrow 200 in the manner described in more detail below, and a latching arrangement 106 for latching the rear end 210 of the wheelbarrow 200 to the towing tongue 102.

As shown in FIG. 1, the towing tongue 102 includes a first end 108 adapted for attachment to the axle 216 between the two wheels 214,214, a second, or hitch end 110 adapted for attachment to the towing vehicle 300, and a tongue body 112 extending between the first and second ends 108,110 of the towing tongue 102. In the first exemplary embodiment of the towing tongue 102 shown in the accompanying illustrations, the second end 110 of the tongue 102 includes a hitch-ball receiver connector, but in other embodiments of the invention the second end might be terminated in another type of hitch connector, such as a drop-pin, or pintle connector, etc.

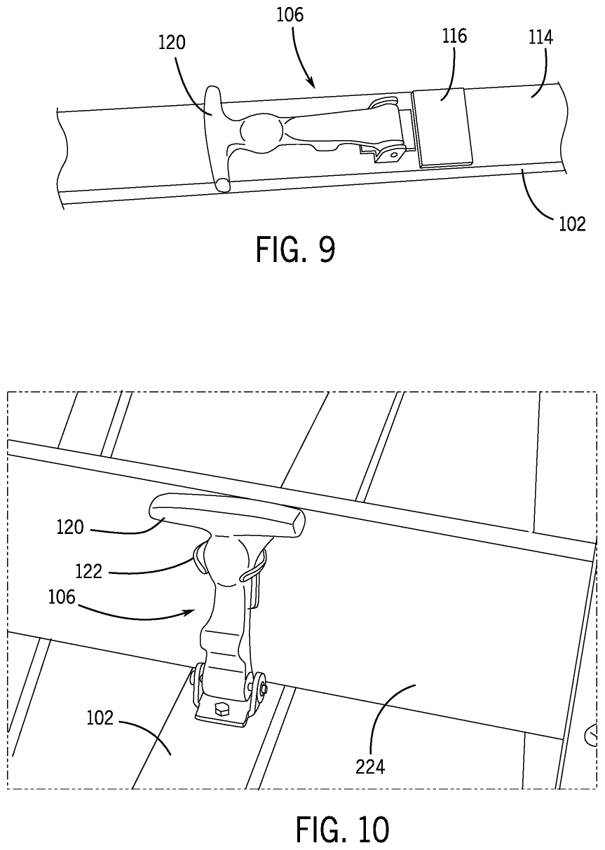

The tongue body 112 defines an upper surface 114 of the tongue 102, and further defines a wheelbarrow intermediate support surface 116 on the upper surface 114 of the tongue 102, which is configured and disposed for engaging the lower surface 212 of the wheelbarrow 200 at a contact point 213 on the lower surface 212 of the wheelbarrow 200 located to the rear of the wheels 214,214. In the first exemplary embodiment of the tongue arrangement 100, the intermediate support surface 116 is provided by a pad attached to the upper surface 116 of the tongue 102 at a point where a portion of the lower surface 212 of the wheelbarrow 200, defining a contact zone 225 on the lower surface 212 of a rear frame crossmember 224 (see FIGS. 4, and 9-10) extending between the rear legs 220 of the wheelbarrow 200, including the contact point 213, comes to rest upon the upper surface 114 of the tongue 102 when the first end 108 of the towing tongue 102 is pivotably attached to the wheelbarrow axle 216 and the hitch end 110 of the towing tongue 102 is raised to a tongue contact height of less than the hitch height 304 from the ground surface 301 as the hitch end 110 of the tongue 102 is lifted toward the hitch height 304.

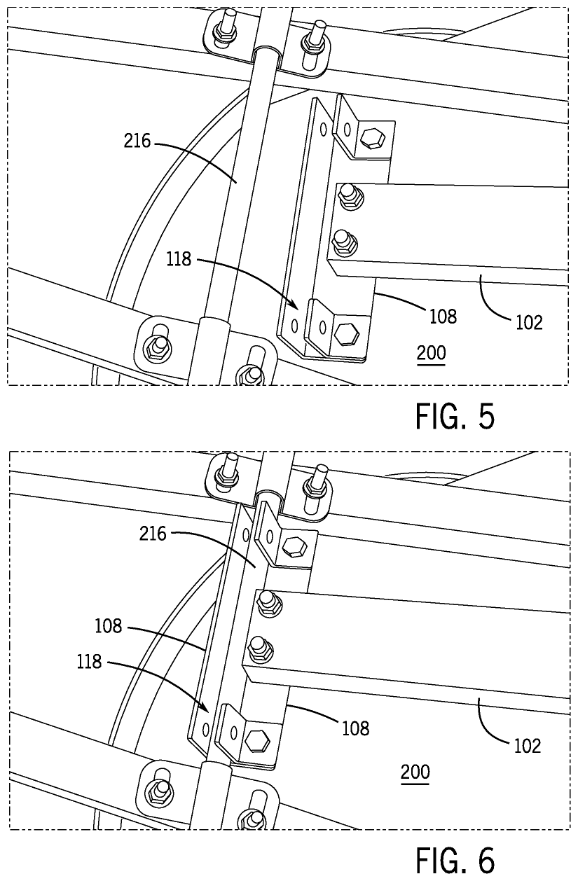

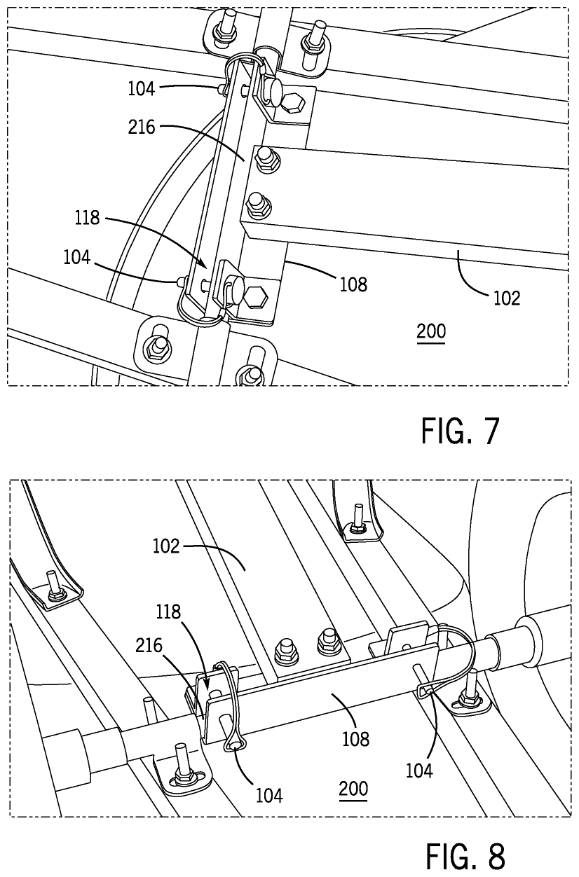

As shown in FIG. 1, and best seen in FIGS. 5-8, the first end 108 of the towing tongue 102 is configured to form a transversely extending slot 118 for receiving the axle 216 of the wheelbarrow 200. In the first exemplary embodiment of the invention, the slot 118 is configured so that the tongue 102 can rotate or pivot about the axle 216 to provide a dump cart capability. Once the first end 108 of the tongue 102 is properly positioned with the axle 216 within the slot 118, the retaining pins 104 are installed to secure the tongue 102 to the wheelbarrow 200. No tools are required.

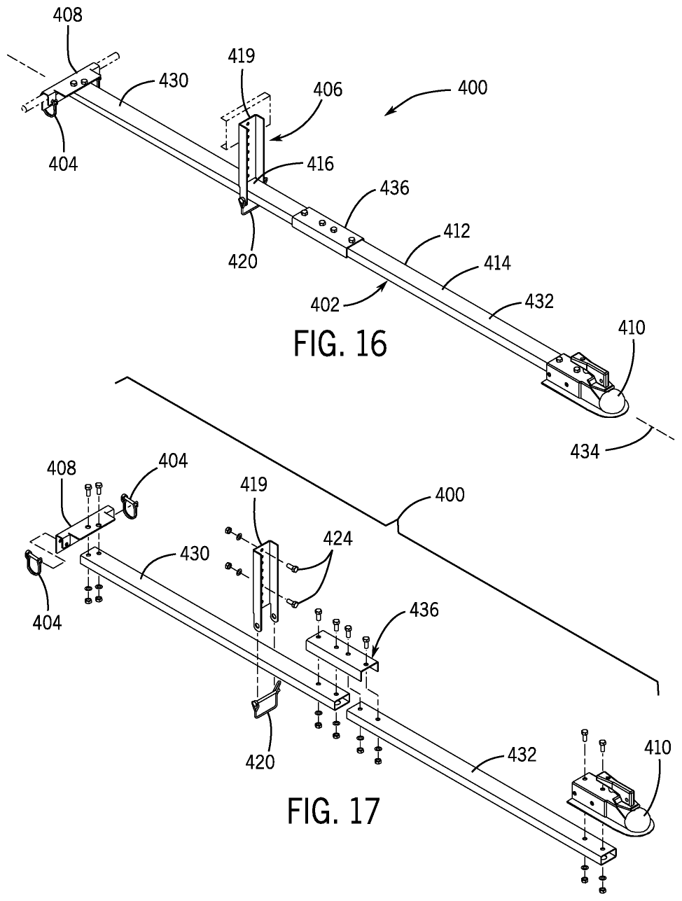

It is noted that the first end of the first exemplary embodiment of the towing tongue 102 described herein and shown in the illustrations is formed from several angle-shaped steel segments that are bolted together to form the first end 108 and define the slot 118. Those having skill in the art will recognize that this is but one example of many configurations that might be used to form the first end 108 of a towing tongue 102 according to the invention, and the invention is intended to encompass all alternative constructions within the scope of the claims as properly construed for all aspects of the invention. One alternative approach to forming the first end of a towing tongue according to the invention is described below in relation to a second exemplary embodiment of a towing tongue apparatus 400, according to the invention, with reference to FIGS. 16 and 17.

As described above, and shown in greater detail in FIGS. 1, 9 and 10, in the first exemplary embodiment of the invention described herein, the upper surface 114 of the towing tongue 102 includes an intermediate support surface 116 in the form of a pad located aft of the wheels 214 of the wheelbarrow 200, upon which the contact point 213 of the lower surface 212, defined by a contact zone 225 located in a central area of the bottom edge of the rear frame cross member 224 of the wheelbarrow 200, will rest when the front end 108 of the tongue 102 is attached to the axle 216 of the wheelbarrow 200 and the tongue 102 is pivoted about the axle 216 to an angle where the intermediate support surface on the upper surface 114 of the body 112 of the tongue 102 comes into contact with the contact zone 213 of the lower surface 212 of the wheelbarrow 200.

Although the first exemplary embodiment of the towing tongue arrangement 100 is configured such that gravitational forces alone would typically hold the wheelbarrow 200 in the transport position 202 on level ground surfaces, the first exemplary embodiment of the towing tongue arrangement 100 includes the latching arrangement 106 to provide additional securement of the wheelbarrow 200 and tongue 102 to one another.

As shown in FIG. 1, in the first exemplary embodiment 100, the latching arrangement includes a T-handle elastomeric hold-down 120 pivotably attached to the upper surface 114 of the tongue 102 at a point just forward of where the rear frame cross member 224 of the wheelbarrow 200 rests on the intermediate support pad 116 of the tongue 102. The latching arrangement 106 also includes a T-handle retaining hook 122 that is attached to the rear frame cross member 224 of the wheelbarrow 200 for receiving the T-handle hold down 120 in such a manner that the tongue 102 and cross member 224 are secured to one another.

By virtue of this arrangement it will be appreciated that, in the first exemplary embodiment 100, the tongue 102 is configured for pivoting the wheelbarrow 200 about the axis of rotation 216 of the wheels 214,214 to raise the rear end supports 222 of the wheelbarrow 200 free of the ground surface 301 when the hitch end 110 of the towing tongue 102 is raised to a tongue contact distance of less than the hitch height 304 from the ground surface 301, and further configured to lift the rear end supports 222 defined by the bottoms of the rear legs 220,220 of the wheelbarrow 200 to a predetermined desired clearance distance 303 (see FIG. 2) above the ground surface 301 when the hitch end 110 of the tongue 102 is lifted to the hitch height 304.

FIGS. 16 and 17 shows a second exemplary embodiment of a towing tongue apparatus 400 according to the invention. As will be appreciated by those having skill in the art comparing FIGS. 16 and 17 to FIG. 1, the second exemplary embodiment 400 includes many of the same features and functions as described above with reference to the first exemplary embodiment 100. The description of the second exemplary embodiment of the towing arrangement 400 will therefore focus on the differences and not repeat a detailed description of the features and functions of the wheelbarrow 200 or the second embodiment of the tongue arrangement 400 which are essentially the same as those previously described above in relation to the first exemplary embodiment 100.

As shown in FIG. 16, the second exemplary embodiment of the towing tongue arrangement 400 includes a towing tongue 402, a pair of retainer pins 404,404 (only one of which is shown in FIG. 16, and both in FIG. 17) for securing the towing tongue 402 to the axle 216 of the two-wheeled wheelbarrow 200 in the manner described in more detail below, and a combination latching/spacer arrangement 406 for latching the rear end 210 of the wheelbarrow 200 to the towing tongue 102, and adjusting the clearance distance 303 between the rear end supports 222 and the ground surface 301, to thereby provide a desired clearance distance 303 when towing the wheelbarrow 200 with the towing vehicle 300.

As shown in FIG. 16, the towing tongue 402 includes a first end 408 adapted for attachment to the axle 216 between the two wheels 214,214, a second, or hitch end 410 adapted for attachment to the towing vehicle 300, and a tongue body 412 extending between the first and second ends 408,410 of the towing tongue 402. In the second exemplary embodiment of the towing tongue 402 shown in the accompanying illustrations, the second end 410 of the tongue 402 includes a hitch-ball receiver connector, but in other embodiments of the invention the second end might be terminated in another type of hitch connector, such as a drop-pin, or pintle connector, etc.

The tongue body 414 defines an upper surface 416 of the tongue 402, and further defines a wheelbarrow intermediate support surface 416 on the upper surface 414 of the tongue 402, which is configured and disposed for engaging the lower surface 212 of the wheelbarrow 200 at a point on an extension of the the lower surface 212 of the wheelbarrow 200 located to the rear of the wheels 214,214, provided by the combination latching/spacer arrangement 406 in a manner described in more detail below.

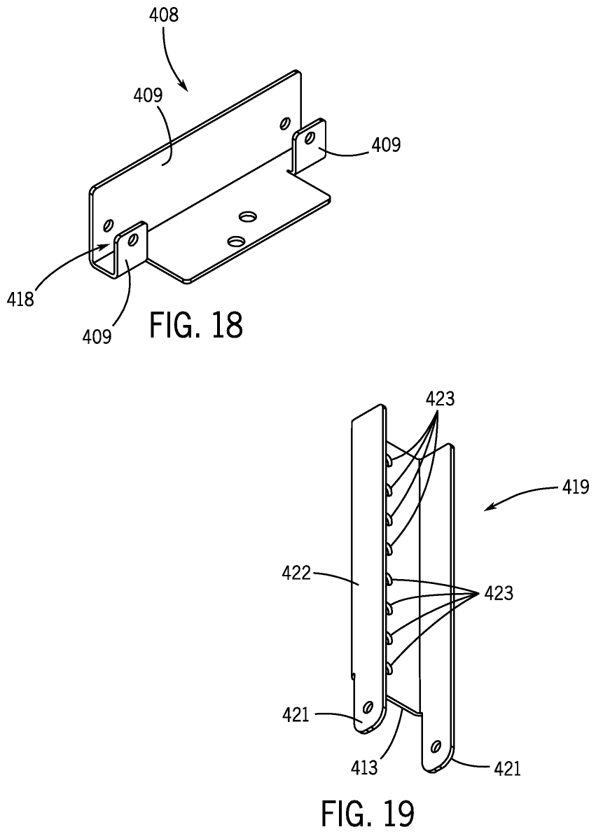

As shown in FIG. 18, the first end 408 of the towing tongue 402 in the second exemplary embodiment of the towing tongue arrangement 400 is configured from formed sheet metal to include a trio of perforated tabs 409,409,409 that cooperatively define a transversely extending slot 418 for receiving the axle 216 of the wheelbarrow 200. In the second exemplary embodiment of the invention 400, the slot 418 is configured so that the tongue 402 can rotate or pivot about the axle 216 to provide a dump cart capability. Once the first end 408 of the tongue 402 is properly positioned with the axle 216 within the slot 418, the retaining pins 404 are installed through aligned holes in the perforated tabs 409,409,409 of the first end 408 to secure the tongue 402 to the wheelbarrow 200. No tools are required.

As shown in FIGS. 16 and 17, in the second exemplary embodiment of the invention 400 towing tongue 402 includes a first and a second section thereof 430,432 extending along a common longitudinal axis 434 of the towing tongue 402 and fixedly joined to one another at respective proximal ends thereof by a coupler 436, with the distal end of the first section 430 of the tongue 402 forming the first end 408 of the tongue 402, and the distal end of the second section 432 of the tongue 402 forming the second end 410 of the tongue 402. The coupler 436 in the second exemplary embodiment 400 of the towing tongue 402 provides a bolted connection so that the first and second sections 430,432 of the tongue may be separated from one another to shorten the overall length of the towing tongue arrangement 400, for the purpose of facilitating shipping or storage of the towing tongue arrangement 400 for example. Alternatively, it is contemplated that in some embodiments of the invention it may be desirable to provide one or more additional tongue extension sections that can be inserted between the first and second sections 430,432 to lengthen a towing arrangement according to the invention to accommodate attachment to wheelbarrows having a greater length or longer handles extending rearward toward the towing vehicle. It is also contemplated that in practicing the invention other types of coupling arrangement might be utilized with efficacy, for example arrangements including locking pins or retainers other than bolted joints.

In some embodiments of the invention, a wheelbarrow 200 used in conjunction with a towing tongue arrangement 100,400 according to the invention will have an overall configuration and define a contact point 213 on the lower surface 212 of the wheelbarrow 200 that will be naturally advantageously positioned such that a desired clearance distance 303 will be achieved between the ground surface 303 and the rear end supports 222 of the wheelbarrow 200 when the contact surface 213 is resting on the intermediate support surface 116,416 of the tongue 102,402.

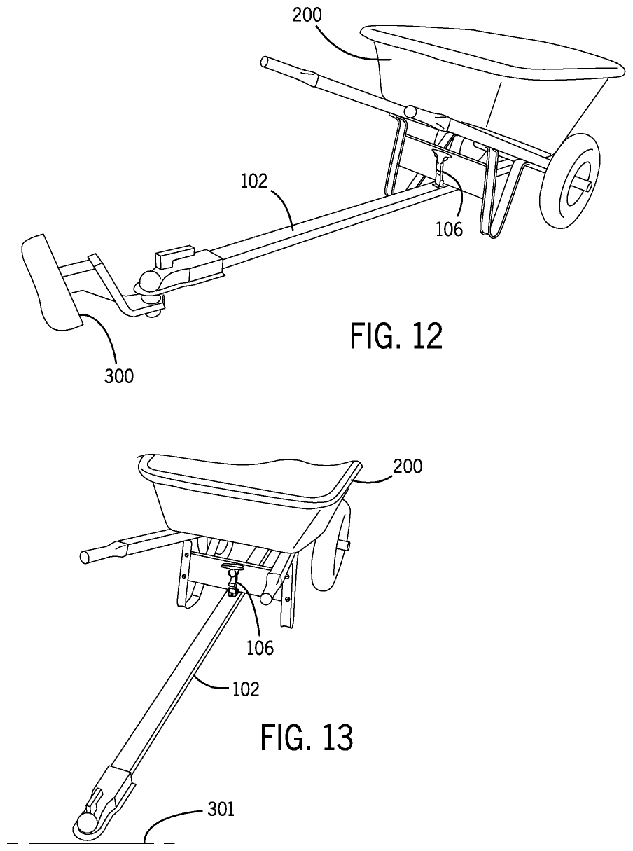

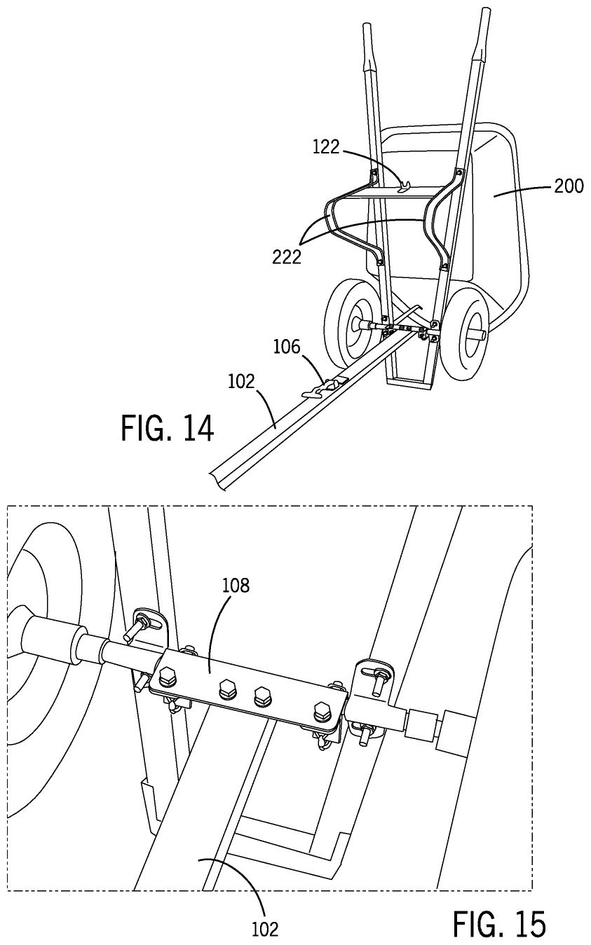

This was the case for the first exemplary embodiment 100 of the invention, as illustrated in FIGS. 2 and 12, where with the second end 110 of the towing tongue 102 attached to the illustrated towing vehicles 300,300 and the contact point 213 on the lower surface 212 of the rear frame crossmember 224 resting upon the upper surface 114 of the tongue 102 the clearance distance 303 was sufficient for operation of the wheelbarrow 200 as a towable cart.

Some combinations of wheelbarrows 200 and towing vehicles 300, however, may not naturally provide a desirable clearance distance 303. In some combinations, for example, the available hitch height 304 at the towing vehicle 300 may be too low or too high to naturally achieve such a result. Also, some wheelbarrows 200 may not have a point on the lower surface 212 that is advantageously positioned to engage the towing tongue 102 at a location along the upper surface 114 of the tongue 102 that can serve as an acceptable intermediate support surface 116 according to the invention.

It is desirable, therefore for some embodiments of the invention to include provisions for extending the lower surface 212 of the wheelbarrow 200 to a location where a contact point 213 can be defined in a spatial relationship with respect to the intermediate support surface 116,416 of the tongue and the rear end supports 222 of the wheelbarrow 200 in combination with the hitch height 304 of the towing vehicle 300 that will result in establishment of a desired clearance distance 303 between the ground surface 301 and the rear supports 222 of the wheelbarrow 200. It is further desirable that some embodiments of the invention include provisions for adjusting the spatial relationship between the contact point 213 and the rear end supports 222.

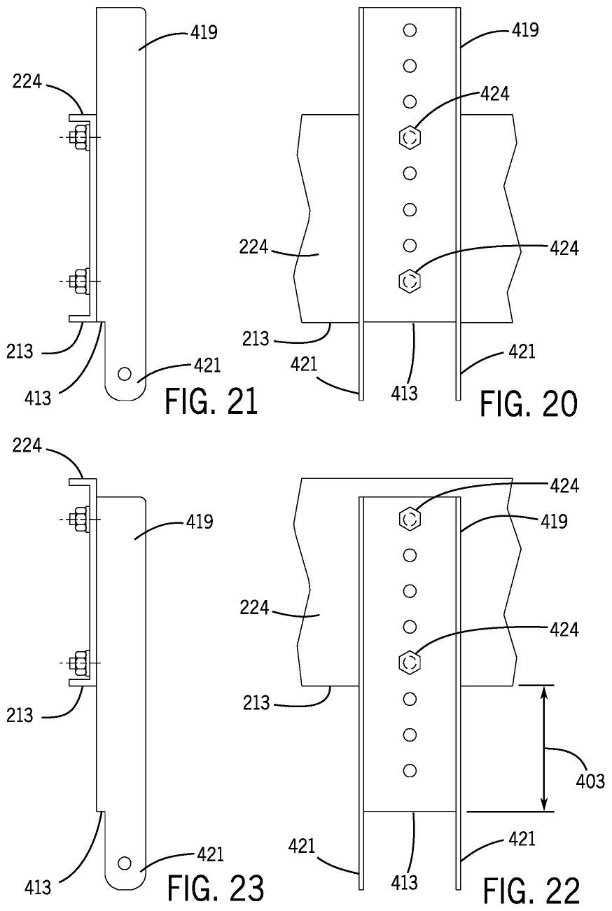

As shown in FIGS. 16, and 20-23, the second exemplary embodiment of the towing arrangement 400 provides for such flexibility of use and adjustability to achieve a desired clearance height 303 through the provision of the latching/spacer arrangement 406.

As shown in FIGS. 16, 17 and 19-23, the exemplary embodiment of the latching/spacer arrangement 406 includes a latching pin 420 that engages aligned holes in a pair of perforated ears 421,421 extending respectively downward from the bottom end of each the legs of a generally U-shaped body 422 of a spacer element 419. The bight area of the spacer element body 422 includes a row of holes 423 spaced along the length of the U-shaped body for receiving fasteners 424,424 for fixedly attaching the spacer element 419 to the wheelbarrow 200 at a point aft of the axle 216 and generally aligned with the intermediate support surface 416 of the towing tongue 402. A portion of the bight area at the lower end of the spacer element 419 is removed to a height above the aligned holes in the perforated ears 421,421 sufficient for receiving the vertical thickness of the towing tongue 402 at the intermediate support surface 416 such that with the spacer element 419 disposed at the intermediate support surface 416 and oriented substantially perpendicular to the towing tongue 402 with the pair of perforated ears 421,421 extending downward along opposite sides of the towing tongue 102, and with the latching pin 420 installed, the towing tongue 402 will be latched and retained within the removed portion of the bight area at the lower end of the spacer element 419.

FIGS. 19-23 illustrate the manner in which the latching/spacer arrangement 406 is configured and utilized, according to the invention, for adjusting the clearance distance 303 between the ground surface 301 and the rear end supports 222 of the wheelbarrow 200.

Using the particular wheelbarrow 200 and towing vehicle 300,300 configurations shown in FIGS. 1-2, 10 and 12 as an example, a towing arrangement according to either the first or second exemplary embodiments 100,400 described herein naturally provide an adequate clearance distance 303, without adjustment, between the ground surface 301 and the rear end supports 222 of the wheelbarrow 200 when a contact point 213 that is part of a contact zone 225 located along the bottom edge of the rear frame crossmember 224 of the wheelbarrow 200 naturally comes to rest upon the intermediate support surface 416 of the towing tongue 402, with the first end 408 of the towing tongue 402 secured to the axle 216 of the wheelbarrow and the second end of the towing tongue 402 secured to the hitches at the respective hitch heights of the towing vehicles 300,300 shown in the illustrations.

As shown in FIGS.19-21, therefore, when utilizing the latching/spacer arrangement 406 of the second exemplary embodiment 400 in such a situation, the spacer element 419 may be attached to the rear frame crossmember 224 using the holes 223 and attachment bolts 224 in such a manner that the lower surface 413 of the bight area between the downward extending ears 421 of the spacer element 419 is horizontally aligned parallel with or slightly above the bottom surface of the rear frame crossmember 224. In this manner the contact point 213 on the bottom edge of the rear frame crossmember will continue to determine and maintain the clearance distance 303 at the same height when the contact point 213 is secured against the intermediate support surface 416 of the towing tongue 402 of the second exemplary embodiment 400 by the latching pin 420 as it did when secured by the T-handle hold-down 120 against the intermediate support surface 116 of the towing tongue 102 of the first exemplary embodiment 100.

As shown in FIGS. 22 and 23, however, if it is desired to increase the clearance distance 303 by a distance 403, the lower surface 413 of the bight area between the downward extending ears 421 of the spacer element 419 may be positioned lower than the natural contact point 213 of the bottom edge of the rear frame crossmember 224 of the wheelbarrow 200 by the distance 403, to thus effectively make the lower surface 413 of the bight area between the downward extending ears 421 of the spacer element 419 an extension of the lower surface 212 of the wheelbarrow 200 and convert the lower surface 413 of the bight area into an extended or alternate contact point 413 of the lower surface of the wheelbarrow 200 that is positioned and configured to contact the intermediate support surface 416 of the towing tongue 402 in a manner resulting in the desired increased clearance distance 303+304 being provided.

It will be understood by those having skill in the art that embodiments of the invention incorporating a spacer element having a form and/or function in accordance with the invention may be utilized to attach a towing tongue arrangement in accordance with the invention to a wheelbarrow that does not otherwise have a contact point on a lower surface that would provide acceptable ground clearance.

It will be further appreciated that the exemplary embodiments of the invention describe apparatuses and methods for providing a towable dump cart arrangement, as formed by the combination of the exemplary embodiments described herein of the two-wheeled wheelbarrow 200 and a towing tongue arrangement 100,400 wherein by rotatably attaching the front end 108,408 of the towing tongue 102,402 to the axle 216 in such a manner that, without detaching the hitch end 110,410 of the towing tongue 102,402 from the towing vehicle 300, the wheelbarrow 200 may be selectively pivoted about the axis of rotation 218 of the wheels 214,214 between a transport position 202 of the wheelbarrow 200 in which the lower surface 212 of the wheelbarrow 200 is supported by the intermediate support surface 116,416 of the tongue 102, to a dump position 204 of the wheelbarrow 200 where the lower surface of the wheelbarrow 212 is pivoted away from the intermediate support surface 116,416 of the tongue.

The exemplary embodiments described herein also demonstrate other advantages and improvements over the prior art such as, latching arrangements 106,406 that are configured for latching and unlatching the wheelbarrow 200 from the tongue 102,402 without the use of tools, and while the wheelbarrow 200 remains hitched to the tow vehicle 300.

As seen in the illustrations of the exemplary embodiments, in practicing the invention with a wheelbarrow 200 having one or more handles extending from the rear 210 of the wheelbarrow 210 for utilizing the wheelbarrow 200 in a manual mode of operation, the towing tongue 102,402 is configured such that the wheelbarrow 200 may be towed by the towing vehicle 300 while the one or more handles 226 are extending from the rear 210 of the wheelbarrow 200, without the need to remove the handles 226. The towing tongue 102,402 according to the exemplary embodiments of the invention described herein, is also configured such that the one or more handles 226 extending from the rear 210 of the wheelbarrow 200 may be used to facilitate moving the wheelbarrow 200 between the transport and dump positions 202,204 of the wheelbarrow 200 while the towing tongue 200 is hitched to the towing vehicle 300.

As a final note, it will be appreciated that the exemplary embodiments of the invention described herein may be practiced without the need for disassembling or modifying the wheelbarrow 200. Although the exemplary embodiment of the latching arrangement 106 described herein in relation to the first exemplary embodiment of a towing tongue apparatus or arrangement 100 according to the invention used a retaining hook 122 that was attached to the rear cross member 224 of the wheelbarrow by mechanical fasteners such as screws 124 or rivets, the inventor contemplates other latching arrangements within the scope of the invention that require no modification of the wheelbarrow 200. As previously noted, the invention may be practiced with efficacy without a latching arrangement. It is also contemplated that in other embodiments, for example, the hold-down element 120 or the retaining hook 122 might be configured to simply hook over the top surface of the rear cross member 224 of the wheelbarrow 200, thus requiring no modification to the wheelbarrow. In similar fashion, it is contemplate that in other embodiments of the invention, the spacer element 419, or a latching/spacer arrangement 406 in accordance with the invention might be attached to the wheelbarrow 200 without the need for screwing or bolting it into the structural members of the wheelbarrow.

It is also contemplated that in embodiments of the invention where the invention is practiced in the form of a convertible wheelbarrow apparatus, or a convertible cart apparatus that includes both a wheelbarrow and a towing tongue configured according to the invention, no modifications of the wheelbarrow would be required in converting between operation of the wheelbarrow in a typical manual mode and operation in a towable cart or towable dump cart mode.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those having skill in the art upon reading the foregoing description. The inventor expects skilled artisans to employ such variations as appropriate and intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. An apparatus for converting a two-wheeled wheelbarrow into a towable cart for transport across a ground surface by a towing vehicle having a hitch defining a hitch height, wherein the wheelbarrow defines a longitudinal axis thereof, front and rear ends thereof and a lower surface thereof and includes a pair of wheels for supporting and transporting the wheelbarrow across the ground surface, the wheels being rotatably affixed adjacent the forward end of the wheelbarrow to an axle in a spaced-apart relationship along a common axis of rotation of the wheels defined by the axle, the axle being attached to the lower surface of the wheelbarrow and extending generally transverse to the longitudinal axis of the wheelbarrow, the lower surface of the wheelbarrow further defining a rear end support for supporting the rear end of the wheelbarrow in a resting position, the apparatus comprising:
a towing tongue having a first end adapted for pivotable attachment to the axle between the two wheels, a second end adapted for attachment to the towing vehicle, and a tongue body extending between the first and second ends;
the tongue body defining an upper surface thereof and further defining a wheelbarrow intermediate support surface configured and disposed for engaging the lower surface of the wheelbarrow at a contact point on the lower surface of the wheelbarrow located to the rear of the wheels and pivoting the wheelbarrow about the axis of rotation of the wheels to raise the rear end support of the wheelbarrow free of the ground surface when the first end of the towing tongue is pivotably attached to the axle and the second end of the towing tongue is raised to a tongue contact distance of less than the hitch height from the ground surface, and further configured to lift the rear end support of the wheelbarrow to a predetermined desired clearance distance above the ground surface when the second end of the tongue is lifted to the hitch height.

2. The apparatus of claim 1, further including a latching arrangement for attaching the body of the towing tongue to the wheelbarrow at a point aft of the wheels.

3. The apparatus of claims 2 wherein, the latching arrangement is configured for latching and unlatching the wheelbarrow from the tongue without the use of tools, and while the wheelbarrow remains hitched to the towing vehicle.

4. The apparatus of claim 3, wherein the latching arrangement comprises at least one of an elastomeric latching member or a removable retaining pin.

5. The apparatus of claim 2, further comprising a spacer element fixedly disposed between the lower surface of the wheelbarrow and the intermediate support surface of the towing tongue, the spacer having a spacer element body configured to raise the rear end support of the wheelbarrow free of the ground surface when the second end of the towing tongue is raised to a tongue contact distance of less than the hitch height from the ground surface, and further configured to lift the rear end support of the wheelbarrow to a predetermined desired clearance distance above the ground surface when the hitch end of the tongue is lifted to the hitch height.

6. The apparatus of claim 5, wherein the spacer element body is configured for fixed attachment in a manner allowing for adjustment of the predetermined desired clearance distance above the ground surface when the hitch end of the tongue is lifted to the hitch height.

7. The apparatus of claim 6, wherein the spacer element body is configured for fixed attachment to the wheelbarrow aft of the wheels and movement with the wheelbarrow as the wheelbarrow is pivoted about the axis of rotation, the spacer element having a lower surface thereof when attached to the wheelbarrow defining an extension of the lower surface of the wheelbarrow and forming the contact point of the lower surface of the wheelbarrow with the intermediate support surface of the towing tongue when the spacer element body is fixedly attached to the wheelbarrow.

8. The apparatus of claim 7, wherein the latching arrangement further comprises the spacer body, with the distal end of the spacer body being configured for engaging the towing tongue and securing the contact point of the extension of the lower surface of the wheelbarrow against the intermediate contact surface of the towing tongue.

9. The apparatus of claim 1, wherein the first end of the towing tongue is rotatably attached to the axle in such a manner that, without detaching the hitch end of the towing tongue from the towing vehicle, the wheelbarrow may be selectively pivoted about the axis of rotation of the wheels between a transport position of the wheelbarrow in which the lower surface of the wheelbarrow is supported by the intermediate support surface of the tongue, to a dump position of the wheelbarrow whereat the lower surface of the wheelbarrow is pivoted away from the intermediate support surface of the tongue.

10. The apparatus of claim 9, wherein the first end of the towing tongue defines a transversely extending slot configured for receiving and retaining the axle of the wheelbarrow between the wheels to thereby pivotably secure the first end of the towing tongue to the wheelbarrow.

11. The apparatus of claim 9, wherein the first end of the towing tongue is configured to be attachable to and detachable from the wheelbarrow without the use of tools.

12. The apparatus of any of claim 1, wherein the wheelbarrow includes one or more handles extending in a normal position from the rear of the wheelbarrow for utilizing the wheelbarrow in a manual mode of operation, and the towing tongue is configured such that the wheelbarrow may be towed by the towing vehicle while the one or more handles are extending in the normal position from the rear of the wheelbarrow.

13. The apparatus of claim 12, wherein:
the first end of the towing tongue is rotatably attached to the axle in such a manner that, without detaching the hitch end of the towing tongue from the towing vehicle, the wheelbarrow may be selectively pivoted about the axis of rotation of the wheels between a transport position of the wheelbarrow in which the lower surface of the wheelbarrow is supported by the intermediate contact surface of the tongue, to a dump position of the wheelbarrow whereat the lower surface of the wheelbarrow is pivoted away from the intermediate support surface of the tongue; and
the towing tongue is configured such that the one or more handles extending from the rear of the wheelbarrow may be used to facilitate moving the wheelbarrow between the transport and dump positions of the wheelbarrow while the towing tongue is hitched to the towing vehicle.

14. The apparatus of claim 1, wherein the tongue further comprises a first and a second section thereof extending along a common longitudinal axis of the tongue and fixedly joined to one another at respective proximal ends thereof by a coupler, the distal end of the first section of the tongue comprising the first end of the tongue, and the distal end of the second section of the tongue comprising the second end of the tongue.

15. A method for converting a two-wheeled wheelbarrow into a towable cart for transport across a ground surface by a towing vehicle having a hitch defining a hitch height, the method comprising:
providing a wheelbarrow defining a longitudinal axis thereof, front and rear ends thereof and a lower surface thereof and including a pair of wheels for supporting and transporting the wheelbarrow across the ground surface, the wheels being rotatably affixed adjacent the forward end of the wheelbarrow to an axle in a spaced-apart relationship along a common axis of rotation of the wheels defined by the axle, the axle being attached to the lower surface of the wheelbarrow and extending generally transverse to the longitudinal axis of the wheelbarrow, the lower surface of the wheelbarrow further defining a rear end support for supporting the rear end of the wheelbarrow in a resting position;
providing a towing tongue apparatus including a towing tongue having a first end adapted for pivotable attachment to the axle between the two wheels, a second end adapted for attachment to the towing vehicle, and a tongue body extending between the first and second ends;
the tongue body defining an upper surface thereof and further defining a wheelbarrow intermediate support surface configured and disposed for contacting the lower surface of the wheelbarrow at a point on the lower surface of the wheelbarrow located to the rear of the wheels along the longitudinal axis and pivoting the wheelbarrow about the axis of rotation of the wheels to raise the rear end support of the wheelbarrow free of the ground surface when the first end of the towing tongue is pivotably attached to the axle and the second end of the towing tongue is raised to a tongue contact distance of less than the hitch height from the ground surface, and further configured to lift the rear end support of the wheelbarrow to a predetermined desired clearance distance above the ground surface when the second end of the tongue is lifted to the hitch height; and
operatively attaching the first end of the towing tongue to the axle of the wheelbarrow between the wheels, with the body of the tongue extending beneath the wheelbarrow along the longitudinal axis of the wheelbarrow, the upper surface of the tongue facing the lower surface of the wheelbarrow, and the second end of the tongue extending from the rear end of the wheelbarrow.

16. The method of claim 15, wherein the towing tongue apparatus further includes a latching arrangement for securing the wheelbarrow to the tongue, and the method further includes securing the wheelbarrow to the tongue with the latching arrangement.

17. The apparatus of claim 15, further comprising a spacer element operatively disposed between the wheelbarrow and the towing tongue, the spacer element having a spacer element body configured to raise the rear end support of the wheelbarrow free of the ground surface when the second end of the towing tongue is raised to a tongue contact distance of less than the hitch height from the ground surface, and further configured to lift the rear end support of the wheelbarrow to a predetermined desired clearance distance above the ground surface when the second end of the tongue is lifted to the hitch height, and the method further comprises utilizing the spacer element to adjust the predetermined desired clearance distance to a desired height.

18. The method of claim 15, further comprising one or more of the following additional steps:
configuring the first end of the towing tongue to be attachable to and detachable from the wheelbarrow without the use of tools;
pivotably attaching the first end of the towing tongue to the axle in such a manner that, without detaching the hitch end of the towing tongue from the towing vehicle, the wheelbarrow may be selectively pivoted about the axis of rotation of the wheels between a transport position of the wheelbarrow in which the lower surface of the wheelbarrow is supported by the intermediate contact surface of the tongue, to a dump position of the wheelbarrow whereat the lower surface of the wheelbarrow is pivoted away from the intermediate support surface of the tongue;
where the wheelbarrow includes one or more handles extending from the rear of the wheelbarrow for utilizing the wheelbarrow in a manual mode of operation, configuring the towing tongue such that the wheelbarrow may be towed by the towing vehicle while the one or more handles are extending in their normal position from the rear of the wheelbarrow;
utilizing the one or more handles extending from the rear of the wheelbarrow to facilitate moving the wheelbarrow between the transport and dump positions of the wheelbarrow while the towing tongue is hitched to the towing vehicle; and
where the tongue further comprises a first and a second section thereof extending along a common longitudinal axis of the tongue and fixedly joinable to one another at respective proximal ends thereof by a coupler, the distal end of the first section of the tongue comprising the first end of the tongue, and the distal end of the second section of the tongue comprising the second end of the tongue, utilizing the coupler to place the tongue in a desired joined or un-joined configuration.

19. A convertible two-wheeled wheelbarrow and towable cart arrangement for transporting loads across a ground surface manually or by a towing vehicle, the convertible wheelbarrow arrangement comprising:
a wheelbarrow defining a longitudinal axis thereof, front and rear ends thereof and a lower surface thereof and including a pair of wheels for supporting and transporting the wheelbarrow across the ground surface, the wheels being rotatably affixed adjacent the forward end of the wheelbarrow to an axle in a spaced-apart relationship along a common axis of rotation of the wheels defined by the axle, the axle being attached to the lower surface of the wheelbarrow and extending generally transverse to the longitudinal axis of the wheelbarrow, the lower surface of the wheelbarrow further defining a rear end support for supporting the rear end of the wheelbarrow in a resting position; and
a towing tongue having a first end adapted for pivotable attachment to the axle between the two wheels, a second end adapted for attachment to the towing vehicle, and a tongue body extending between the first and second ends;
the tongue body defining an upper surface thereof and further defining a wheelbarrow intermediate support surface configured and disposed for contacting the lower surface of the wheelbarrow at a contact point on the lower surface of the wheelbarrow located to the rear of the wheels along the longitudinal axis and pivoting the wheelbarrow about the axis of rotation of the wheels to raise the rear end support of the wheelbarrow free of the ground surface when the first end of the towing tongue is pivotably attached to the axle and the second end of the towing tongue is raised to a tongue contact distance of less than the hitch height from the ground surface, and further configured to lift the rear end support of the wheelbarrow to a predetermined desired clearance distance above the ground surface when the second end of the tongue is lifted to the hitch height.

20. The convertible two-wheeled wheelbarrow and towable cart arrangement of claim 19, further comprises at least one of a latching arrangement for securing the contact point of the lower surface wheelbarrow to the intermediate support surface of the towing tongue, or a spacer element operatively disposed between the wheelbarrow and the towing tongue, the spacer element having a spacer element body configured to raise the rear end support of the wheelbarrow free of the ground surface when the second end of the towing tongue is raised to a tongue contact distance of less than the hitch height from the ground surface, and further configured to lift the rear end support of the wheelbarrow to a predetermined desired clearance distance above the ground surface when the second end of the tongue is lifted to the hitch height.
